(19) United States
(12) Patent Application Publication
(10) Pub. No.: US 2013/0249538 A1
(43) Pub. Date: Sep. 26, 2013

(54) ROTATION ANGLE AND TORQUE DETECTION DEVICE

(71) Applicant: PANASONIC CORPORATION, Osaka (JP)

(72) Inventors: KOUJI OIKE, Kyoto (JP); KIYOTAKA SASANOUCHI, Osaka (JP); SHINJI HIROSE, Gifu (JP)

(73) Assignee: PANASONIC CORPORATION, Osaka (JP)

(21) Appl. No.: 13/794,889

(22) Filed: Mar. 12, 2013

(30) Foreign Application Priority Data
Mar. 26, 2012 (JP) 2012-069309

(51) Int. Cl. G01B 7/30

(52) U.S. Cl. CPC G01B 7/30
USPC 324/207.25

(57) ABSTRACT

A rotation angle and torque detection device includes a first rotating body, a second rotating body, a first magnet, a first magnetism detecting element, a first detecting body, a second magnet, a second magnetism detecting element, a second detecting body, a third magnet, a third magnetism detecting element, and a control circuit. The control circuit outputs a rotation torque signal and a rotation angle signal. The first magnetism detecting element outputs a torque detection signal.

### TECHNICAL FIELD

The present technical field relates to a rotation angle and torque detection device mainly used for detecting a rotation angle and rotation torque of steering of an automobile.

### BACKGROUND ART

In recent years, a brake, power steering, or the like, of an automobile has been controlled by detecting a rotation angle and rotation torque of steering of an automobile by using a rotation angle detection device or a rotation torque detection device.

FIG. 5 is an exploded perspective view of a conventional rotation angle and torque detection device. Cylindrical first rotating body 1 rotates together with steering of an automobile. Cylindrical first magnet 3 includes a plurality of N-poles and S-poles that are formed alternately and adjacently. First magnet 3 is fixed to the outer periphery of a lower end of cylindrical holding body 2. The outer periphery of an upper part of holding body 2 is fixed to an upper part of the inner periphery of first rotating body 1.

Cylindrical second rotating body 4 is disposed in the lower side of first rotating body 1. Ring-shaped first magnetic body 5 and ring-shaped second magnetic body 6 are disposed with spacer 7 interposed therebetween on second rotating body 4. First magnetic body 5 and second magnetic body 6 are disposed with a predetermined space with respect to the outer periphery of first magnet 3. First magnetic body 5 is provided with a plurality of protruding portions 5A on the inner periphery thereof. Second magnetic body 6 is provided with a plurality of protruding portions 6A on the inner periphery thereof.

Wiring board 8 is disposed on the side parts of first rotating body 1 and second rotating body 4. Wiring board 8 has a plurality of wirings (not shown) on both surfaces thereof. First magnetism detecting element 9 such as a Hall element is laid out on the outside of spacer 7 such that it faces first magnet 3.

Spur gear 4A formed on the lower surface of the outer periphery of second rotating body 4 meshes with spur gear 10A of first detecting body 10. Furthermore, spur gear 10A meshes with spur gear 11A of second detecting body 11. The number of cogs of spur gear 10A is different from the number of cogs of spur gear 11A.

Second magnet 12A is mounted on the middle of first detecting body 10 by, for example, insert molding. Third magnet 13A is mounted on the middle of second detecting body 11 by, for example, insert molding. Second magnetism detecting element 12B such as an AMR (anisotropic magnetic resistance) element is mounted on a surface that faces second magnet 12A in wiring board 8. Third magnetism detecting element 13B such as an AMR element is mounted on a surface that faces third magnet 13A in wiring board 8.

Wiring board 8 includes control circuit 14 formed of an electronic component such as microcomputer. First magnetism detecting element 9, second magnetism detecting element 12B, and third magnetism detecting element 13B are coupled to control circuit 14 via wirings (not shown).

The upper end of connecting body 15 such as a columnar torsion bar made of, for example, copper is fixed to first rotating body 1, and the lower end thereof is fixed to second rotating body 4, respectively. The rotation angle and torque detection device configured as mentioned above is attached to a steering shaft of an automobile and mounted on the lower side of the steering. Control circuit 14 is coupled to an electronic circuit (not shown) of an automobile main body via a connector, a lead wire (not shown), or the like.

Turning the steering allows first rotating body 1 to rotate and connecting body 15 to twist. Then, second rotating body 4 is rotated after a slight delay from the rotation of first rotator 1. For example, when a vehicle runs, the delay of second rotating body 4 relative to first rotating body 1 is small because rotation torque is small. On the other hand, when the vehicle is stopping, the delay of second rotating body 4 becomes large because the rotation torque is large.

According to the rotation of first rotating body 1, first magnet 3 is rotated. Then, according to the rotation of second rotating body 4, first magnetic body 5 and second magnetic body 6 are also rotated after a slight delay from the rotation of first magnet 3. First magnetism detecting element 9 detects magnetic variations of the N-poles and S-poles formed alternately and adjacently of first magnet 3 via first magnetic body 5 and second magnetic body 6, and this torque detection signal is input into control circuit 14.

First magnet 3 is fixed to first rotating body 1. Second magnetic body 6 is fixed to second rotating body 4. Magnetism detected by first magnetism detecting element 9 is weak when a delay of the rotation of second rotating body 4 is small with respect to first rotating body 1, and strong when the delay of the rotation is large.

Based on strength and weakness of the magnetism detected by first magnetism detecting element 9 via first magnetic body 5 and second magnetic body 6, control circuit 14 calculates rotation torque of first rotating body 1 (that is, rotation torque of the steering). Then, control circuit 14 outputs a rotation torque signal to an electronic circuit of a vehicle main body.

Furthermore, since spur gear 4A formed on the lower surface of the outer periphery of second rotating body 4 is rotated according to the rotation of second rotating body 4, first detecting body 10 and second detecting body 11 rotate together with each other.

According to the rotation of first detecting body 10 and second detecting body 11, second magnet 12A and third magnet 13A are also rotated. Second magnetism detecting element 12B detects magnetism by second magnet 12A. Third magnetism detecting element 13B detects magnetism by third magnet 13A. Magnetic variations detected by second magnetism detecting element 12B and third magnetism detecting element 13B are input as sine wave, cosine wave, or a saw-tooth angle detection signal into control circuit 14.

The number of cogs of spur gear 10A of first detecting body 10 is different from that of spur gear 11A of second detecting body 11. Therefore, an angle detection signal output from second magnetism detecting element 12B is different from an angle detection signal output from third magnetism detecting element 13B in terms of inclining angles and shapes of waveforms, so that those signals are input into control circuit 14 as signals having a phase difference.

Then, control circuit 14 calculates a rotation angle of second rotating body 4, that is, a rotation angle of the steering by carrying out a predetermined arithmetic operation based on the two different angle detection signals from first detecting body 10 and second detecting body 11 and the numbers of spur gear 10A and spur gear 11A. Then, control circuit 14 outputs a rotation angle signal to the electronic circuit of an automobile main body. The electronic circuit arithmetically operates the rotation angle signal or the rotation torque signal of the above-mentioned control circuit 14, and controls power steering, a brake, or the like.

In other words, control circuit 14 calculates the rotation torque of the steering based on the torque detection signal from first magnetism detecting element 9, and calculates the rotation angle based on the angle detection signal from second magnetism detecting element 12B and third magnetism detecting element 13B. In response to the rotation torque signal or the rotation angle signal output from control circuit 14, the electronic circuit carries out control of effectiveness of a brake corresponding to the rotation angle of the steering, control of force to rotate the steering, or the like.

### SUMMARY

A rotation angle and torque detection device includes a first rotating body, a second rotating body, a first magnet, a first magnetism detecting element, a first detecting body, a second magnet, a second magnetism detecting element, a second detecting body, a third magnet, a third magnetism detecting element, and a control circuit. The control circuit outputs a rotation torque signal and a rotation angle signal. The first magnetism detecting element outputs a torque detection signal.

### BRIEF DESCRIPTION OF THE DRAWINGS

FIG. 1 is a sectional view of a rotation angle and torque detection device in accordance with an embodiment.

FIG. 2 is an exploded perspective view of the rotation angle and torque detection device shown in FIG. 1.

FIG. 3 is a view for illustrating relation between a first magnet and third magnetic bodies of the rotation angle and torque detection device when steering is stationary in accordance with this embodiment.

FIG. 4 is a view for illustrating the relation between the first magnet and the third magnetic bodies of the rotation angle and torque detection device when the steering is turned in accordance with this embodiment.

FIG. 5 is an exploded perspective view of a conventional rotation angle and torque detection device.

### DETAILED DESCRIPTION

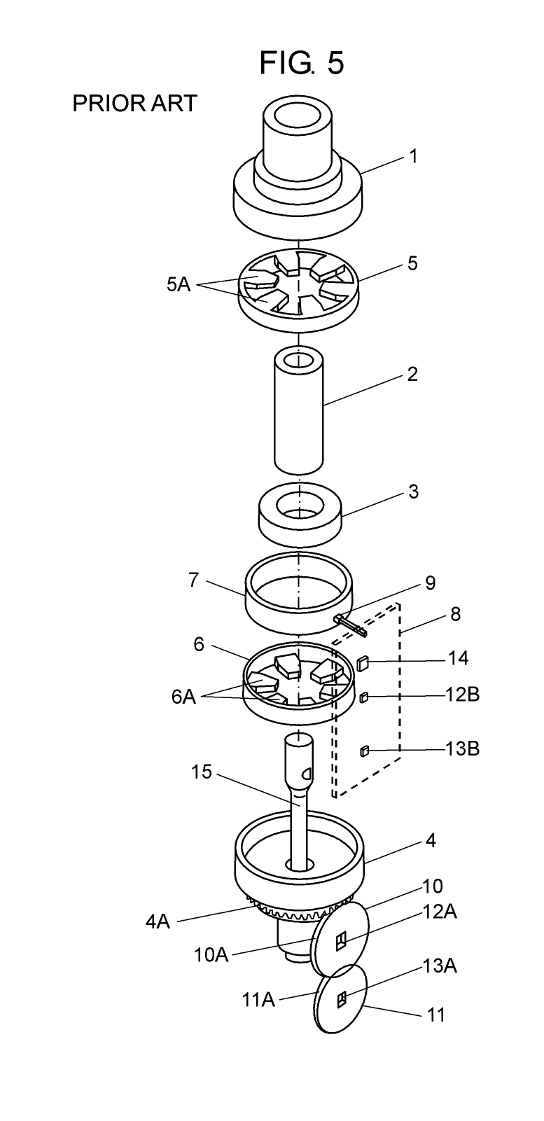

In a rotation angle and torque detection device shown in FIG. 5, a rotation torque signal and a rotation angle signal are output from control circuit 14 to an electronic circuit of a vehicle. However, when failure such as breakdown occurs in control circuit 14, neither rotation torque signal nor rotation angle signal is input into the electronic circuit. Consequently, the electronic circuit cannot determine whether control circuit 14 has failure or the steering is not turned. In order to sense this, it is necessary to provide another sensor or the like, and to detect rotation of first rotating body 1, second rotating body 4, or the like, resulting in making the configuration complicated and expensive.

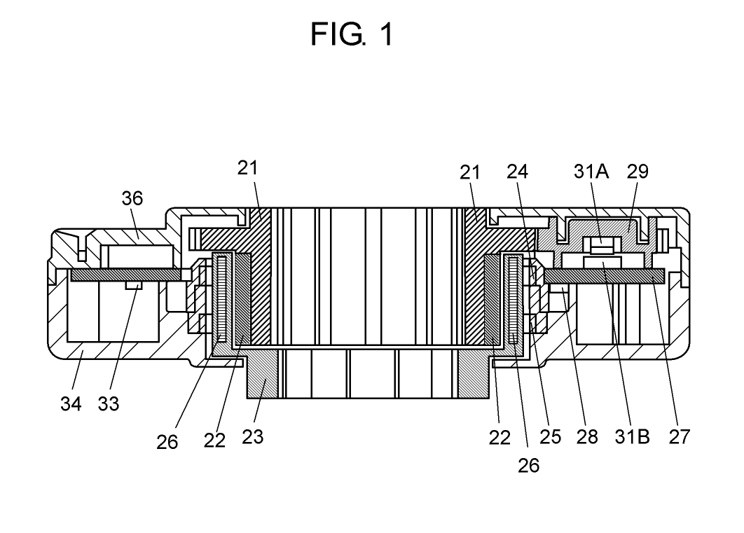

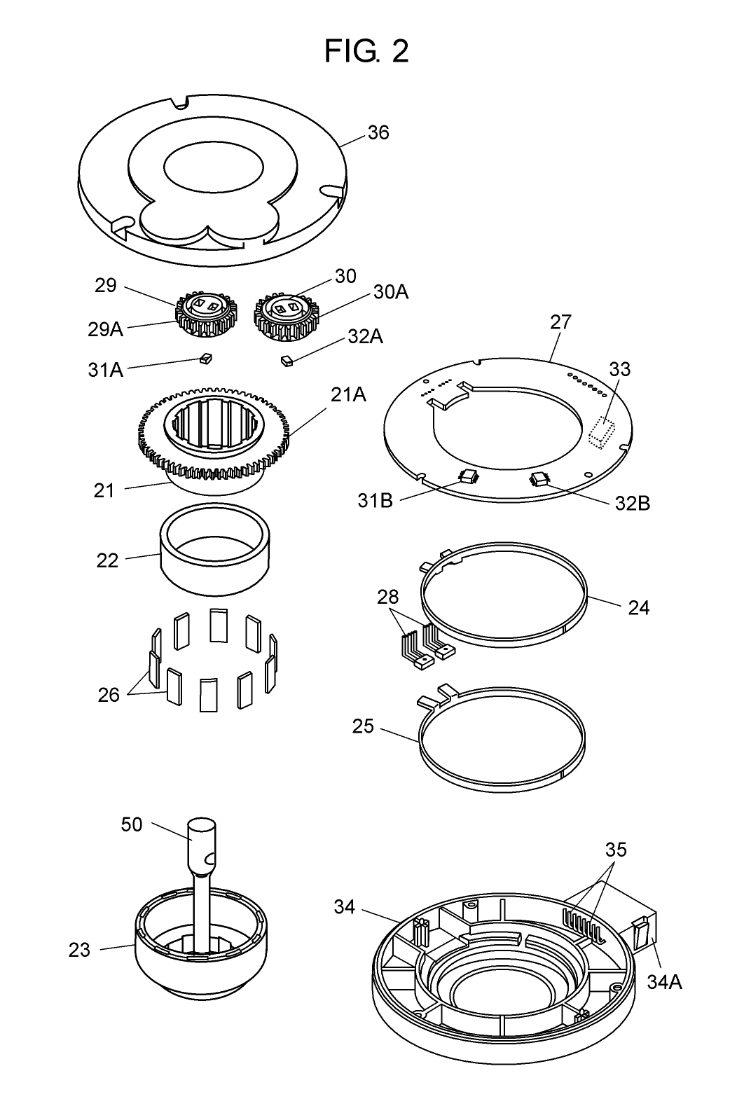

Hereinafter, a rotation angle and torque detection device in accordance with this embodiment is described. FIG. 1 is a sectional view of a rotation angle and torque detection device in accordance with an embodiment. FIG. 2 is an exploded perspective view of the rotation angle and torque detection device shown in FIG. 1.

The rotation angle and torque detection device includes first rotating body 21, second rotating body 23, first magnet 22, first magnetism detecting element 28, first detecting body 29, second magnet 31A, second magnetism detecting element 31B, second detecting body 30, third magnet 32A, third magnetism detecting element 32B, and control circuit 33. Control circuit 33 outputs a rotation torque signal and a rotation angle signal, while first magnetism detecting element 28 outputs a torque detection signal. The rotation angle and torque detection device further includes first magnetic body 24, second magnetic body 25, third magnetic body 26, and wiring board 27.

Cylindrical first rotating body 21 rotates together with steering, and has spur gear 21A on the outer periphery thereof. First rotating body 21 is made of insulating resin such as polybutylene terephthalate.

First magnet 22 is fixed to the outer periphery of first rotating body 21, and on the lower surface of spur gear 21A. Cylindrical first magnet 22 includes a plurality of N-poles and S-poles formed alternately and adjacently in the circumferential direction. First magnet 22 is made of ferrite, Nd—Fe—B alloy, or the like.

Cylindrical second rotating body 23 is disposed in the lower side of first rotating body 21. First magnetic body 24 and second magnetic body 25 are disposed so as to surround first magnet 22. First magnetic body 24 and second magnetic body 25 are formed by winding a belt-like plate material in a ring shape. Second rotating body 23 is made of insulating resin such as polybutylene terephthalate. Both first magnetic body 24 and second magnetic body 25 are made of permalloy, iron, Ni—Fe alloy, or the like.

A plurality of rectangular third magnetic bodies 26 are arranged by insert molding, press-hitting, or the like, at a predetermined interval inside second rotating body 23. Second rotating body 23 is disposed on the outside of first magnet 22 and inside of first magnetic body 24 and second magnetic body 25. Third magnetic body 26 is made of permalloy, iron, Ni—Fe alloy, or the like.

Wiring board 27 made of paper phenol, glass-containing epoxy, or the like, is disposed so as to surround the outer periphery of second rotating body 23. On the upper and lower surfaces of wiring board 27, a plurality of wirings (not shown) are formed of, for example, copper foil. A plurality of first magnetism detecting elements 28 are disposed such that they face first magnet 22 between first magnetic body 24 and second magnetic body 25. First magnetism detecting elements 28 are formed of, for example, a Hall element for detecting magnetism in the vertical direction or a GMR element (giant magnetoresistive element) for detecting magnetism in the horizontal direction.

First detecting body 29 is made of insulating resin or metal, and has spur gear 29A on the outer periphery of the side surface. Second detecting body 30 is made of insulating resin or metal and has spur gear 30A whose number of cogs is different from that of spur gear 29A on the outer periphery of the side surface. Spur gear 21A of first rotating body 21 and spur gear 29A of first detecting body 29 mesh with each other. Furthermore, spur gear 29A of first detecting body 29 and spur gear 30A of second detecting body 30 mesh with each other.

Note here that the diameter and the number of cogs of the gear are largest in first rotating body 21, and they become smaller in first detecting body 29, and second detecting body 30 in this order. For example, the number of cogs of spur gear 21A is 48, the number of cogs of spur gear 29A is 32, and the number of cogs of spur gear 30A is 28.

Furthermore, in the middle part of first detecting body 29, second magnet 31A made of ferrite, Nd—Fe—B alloy, or the like, is mounted by, for example, insert molding. In the middle part of second detecting body 30, third magnet 32A made of ferrite, Nd—Fe—B alloy, or the like, is mounted by, for example, insert molding. Second magnetism detecting element 31B such as an AMR (anisotropic magnetic resistance) element is mounted on the surface that faces second magnet 31A in wiring board 27. Third magnetism detecting element 32B such as an AMR element is mounted on the surface that faces third magnet 32A in wiring board 27.

Wiring board 27 includes control circuit 33 formed of an electronic component such as microcomputer. A plurality of first magnetism detecting elements 28, second magnetism detecting element 31B, and third magnetism detecting element 32B are coupled to control circuit 33 via wirings.

Furthermore, case 34 is provided with connect part 34A. Case 34 is made of insulating resin with its upper surface opened. Connect part 34A has a plurality of terminals 35 of, for example, copper alloy, attached thereon. The plurality of terminals 35 are connected to wiring board 27. At least one of second magnetism detecting element 31B and third magnetism detecting element 32B, a plurality of first magnetism detecting elements 28, and control circuit 33 are coupled to a plurality of terminals 35 via wiring.

Cover 36 made of insulating resin covers the upper surface of case 34. First rotating body 21, second rotating body 23, wiring board 27, and the like, are accommodated inside cover 36 and case 34.

Then, connecting body 50 that is a columnar torsion bar made of, for example, copper, is fixed to first rotating body 21 at the upper end (first end) thereof, and fixed to second rotating body 23 at the lower end (second end) thereof, respectively. The rotation angle and torque detection device configured as mentioned above is attached to a steering shaft, and mounted on the lower side of steering of an automobile. First magnetism detecting element 28 and control circuit 33 are coupled to an electronic circuit (not shown) of an automobile main body via a plurality of terminals 35, lead wires (not shown), or the like.

Turning the steering allows first rotating body 21 to rotate and connecting body 50 to twist. Then, second rotating body 23 is rotated after a slight delay from the rotation of first rotator 21. For example, when a vehicle runs, the delay of second rotating body 23 relative to first rotating body 21 is small because rotation torque is small. On the other hand, when the vehicle is stopping, the delay of second rotating body 23 becomes large because the rotation torque is large.

According to the rotation of first rotating body 21, first magnet 22 is rotated. Then, after a slight delay from the rotation of first rotating body 21, second rotating body 23 is also rotated. First magnetism detecting element 28 detects magnetic variations of the N-poles and S-poles of first magnet 22 via first magnetic body 24, second magnetic body 25, and third magnetic body 26, and output them as a torque detection signal to control circuit 33 and an electronic circuit of a vehicle.

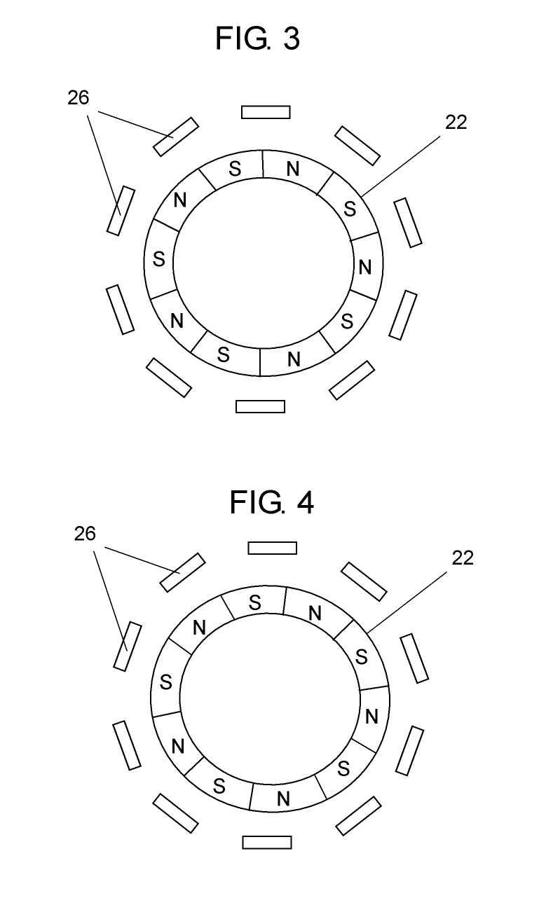

FIG. 3 is a view for illustrating relation between first magnet 22 and third magnetic bodies 26 when steering is stationary. When steering is not turned and is in a neutral position, and an automobile travels straight, each of centers of the plurality of third magnetic bodies 26 faces each of dividing lines between the N-poles and S-poles, which are arranged alternately and adjacently on the outer periphery of first magnet 22, with a predetermined space. Accordingly, magnetism from the N-pole to the S-pole is in a balanced state.

Therefore, since a magnetic flux is not generated between first magnetic body 24 and second magnetic body 25 on the outside of the plurality of third magnetic bodies 26, the magnetism detected by first magnetism detecting element 28 is 0.

FIG. 4 is a view for illustrating the relation between first magnet 22 and third magnetic bodies 26 when the steering is turned. In a state in which the steering is turned to right or left, first magnet 22 is rotated, and each of the centers of third magnetic bodies 26 is displaced relative to each of the division lines of the N-poles and S-poles of first magnet 22, magnet 22 generates a magnetic flux as a closed magnetic circuit from the N-pole to the S-pole on third magnetic bodies 26.

Furthermore, at the same time, first magnet 22 generates a magnetic flux from the N-pole to the S-pole, also in first magnetic body 24 and second magnetic body 25. Consequently, first magnetism detecting element 28 detects the magnetism, and a predetermined voltage waveform corresponding to the strength and weakness of the magnetism is output as a torque detection signal to control circuit 33 and the electronic circuit of a vehicle.

At this time, when the rotation torque is small, the delay of second rotating body 23 relative to first rotating body 21, which is expressed by an angle, is about 1°. On the other hand, when the rotation torque is large, the delay expressed by an angle is about 4°. The magnetism detected by first magnetism detecting element 28 is weak when the delay of rotation of second rotating body 23 to which third magnetic bodies 26 are fixed is small relative to first rotating body 21 to which first magnet 22 is fixed, and the magnetism is stronger when the delay of the rotation is large.

Then, control circuit 33 calculates the rotation torque of first rotating body 21 (that is, the rotation torque of the steering) from the strength and weakness of the magnetism of first magnetism detecting element 28, which is detected via first magnetic body 24, second magnetic body 25, and third magnetic body 26; and outputs the calculated torque as a rotation torque signal to the electronic circuit of a vehicle main body.

Furthermore, according to the rotation of first rotating body 21, first detecting body 29 and second detecting body 30 are rotated.

Then, according to the rotation of first detecting body 29, second magnet 31A is rotated. Furthermore, according to the rotation of second detecting body 30, third magnet 32A is rotated. Second magnetism detecting element 31B detects magnetic variation of second magnet 31A. Third magnetism detecting element 32B detects magnetic variation of third magnet 32A. The magnetic variation detected by second magnetism detecting element 31B is input as sine wave, cosine wave, or a saw-tooth angle detection signal (first angle detection signal) into control circuit 33. Furthermore, the magnetic variation detected by third magnetism detecting element 32B is input as sine wave, cosine wave, or a saw-tooth angle detection signal (second angle detection signal) into control circuit 33.

The number of cogs of spur gear 29A of first detecting body 29 is different from that of spur gear 30A of second detecting body 30. Therefore, the first angle detection signal output from second magnetism detecting element 31B and the second angle detection signal output from third magnetism detecting element 32B are different from each other in terms of inclining angles and shapes of waveforms, so that the signals have a phase difference.

Control circuit 33 calculates a rotation angle of first rotating body 21 (that is, a rotation angle of steering) by carrying out a predetermined arithmetic operation based on the two different angle detection signals from first detecting body 29 and second detecting body 30 and the numbers of cogs of the respective spur gears. Then, control circuit 33 outputs a rotation angle signal to an electronic circuit of an automobile main body. The electronic circuit arithmetically operates the rotation angle signal and the above-mentioned control circuit arithmetically operates the rotation torque signal so as to control power steering, a brake, or the like.

In other words, the electronic circuit controls the steering in response to a running state or a stopping state of a vehicle. For example, when the rotation torque of the steering is small during running of the vehicle, the electronic circuit loosens the effectiveness of a power steering device so that the steering is turned with large force to some extent. When the rotation torque of the steering is large during stop of the vehicle, the electronic circuit strengthens the effectiveness of the power steering device so that the steering can be turned even with small force.

Alternatively, controls of the brake or the like are carried out in response to the turning of the steering based on the rotation angle signal from control circuit 33. For example, control circuit 33 makes the effectiveness of the brake intermittent when the steering is turned by a large amount, while it makes the effectiveness of the brake constant when the steering is turned by a small amount.

Then, in this embodiment, a rotation torque signal and a rotation angle signal of first rotating body 21 are output from control circuit 33 to an electronic circuit of a vehicle via a plurality of terminals 35. Furthermore, the torque detection signal is output also from first magnetism detecting element 28 via terminals 35. Therefore, even if failure such as breakdown occurs in control circuit 33, the electronic circuit can detect the failure.

That is to say, when the steering is turned in a state in which failure such as breakdown occurs in control circuit 33, first rotating body 21, second rotating body 23, first detecting body 29 and second detecting body 30 are rotated together with the steering. In this case, a rotation torque signal or a rotation angle signal is not output from control circuit 33, but a torque detection signal is output to the electronic circuit from first magnetism detecting element 28 via terminals 35. Therefore, the electronic circuit can detect failure in control circuit 33 based on the torque detection signal.

In other words, when a rotation torque signal or a rotation angle signal is not output from control circuit 33 but a torque detection signal is output from first magnetism detecting element 28, the electronic circuit determines that failure occurs in control circuit 33. Furthermore, when a rotation torque signal and a rotation angle signal are not output from control circuit 33, and also a torque detection signal is not output from first magnetism detecting element 28, the electronic circuit determines that a steering is not turned.

Furthermore, a plurality of first magnetism detecting elements 28 are provided between first magnetic body 24 and second magnetic body 25, and the plurality of first magnetic elements 28 detect magnetism of first magnet 22. Thereby, when damage, breakdown, or the like, occurs in one of first magnetism detecting elements 28, control circuit 33 can detect the breakdown or the like.

In the above description, a configuration is described in which a rotation torque signal and a rotation angle signal are output from control circuit 33, and a torque detection signal is output from first magnetism detecting element 28. However, a configuration may be employed in which a first angle detection signal or a second angle detection signal is output to the electronic circuit of a vehicle from second magnetism detecting element 31B or third magnetism detecting element 32B via terminals 35, thereby allowing the electronic circuit to sense failure of control circuit 33.

Furthermore, this embodiment describes a configuration in which first rotating body 21 and first detecting body 29 mesh with each other, and first detecting body 29 and second detecting body 30 mesh with each other. However, both first detecting body 29 and second detecting body 30 may be allowed to mesh with first rotating body 21. Alternatively, first detecting body 29 and second detecting body 30 are allowed to mesh with each other, and only one of them may be allowed to mesh with first rotating body 21. In addition, second rotating body 23 may be provided with a spur gear with which first detecting body 29 and second detecting body 30 may be allowed to mesh. Furthermore, a configuration is not limited to the configuration in which first rotating body 21 and first detecting body 29 mesh with each other, and first detecting body 29 and second detecting body 30 mesh with each other. Any configurations may be employed as long as first rotating body 21, first detecting body 29, and second detecting body 30 are rotated together with each other. In addition, second rotating body 23, first detecting body 29, and second detecting body 30 may rotate together with each other. The rotating together includes rotating without having a contact portion. For example, as in first rotating body 21 and second rotating body 23, a configuration in which rotation is carried out via connecting body 50 or the like may be employed. Note here that the rotating together other than meshing includes a configuration in which rotation is carried out via, for example, a rotation belt.

In this way, in accordance with this embodiment, the rotation torque signal or the rotation angle signal are output from control circuit 33, and, at the same time, at least one of the torque detection signal and the angle detection signal is output from at least one of first magnetism detecting element 28, second magnetism detecting element 31B, and third magnetism detecting element 32B. Thus, in addition to the rotation torque signal and the rotation angle signal from control circuit 33, the torque detection signal from first magnetism detecting element 28, or the angle detection signal from second magnetism detecting element 31B and third magnetism detecting element 32B is also output to the electronic circuit of a vehicle. Therefore, even if failure such as breakdown occurs in control circuit 33, failure can be sensed based on the torque detection signal from first magnetism detecting element 28, or the angle detection signal from second magnetism detecting element 31B and third magnetism detecting element 32B. As a result, the rotation angle and torque detection device of this embodiment enables a rotation angle and rotation torque to be detected reliably with a simple configuration without necessity of providing, for example, a new sensor.

A rotation angle and torque detection device in accordance with this embodiment has an advantageous effect that a rotation angle and rotation torque can be detected reliably with a simple configuration, and is mainly useful in detection of a rotation angle or rotation torque for a steering of an automobile.

What is claimed is:

1. A rotation angle and torque detection device comprising:
a first rotating body;
a second rotating body that rotates together with the first rotating body;
a first magnet mounted on the first rotating body;
a first magnetism detecting element for detecting magnetism of the first magnet, and outputting it as a torque detection signal;
a first detecting body that rotates together with the first rotating body or the second rotating body;
a second magnet mounted on the first detecting body;
a second magnetism detecting element for detecting magnetism of the second magnet and outputting it as a first angle detection signal;
a second detecting body that rotates together with the first detecting body or the first rotating body;
a third magnet mounted on the second detecting body;
a third magnetism detecting element for detecting magnetism of the third magnet and outputting it as a second angle detection signal; and
a control circuit coupled to the first magnetism detecting element, the second magnetism detecting element, and the third magnetism detecting element,
wherein the first magnetism detecting element outputs the torque detection signal to the control circuit and to outside of the rotation angle and torque detection device; and
the control circuit calculates rotation torque of the first rotating body from the torque detection signal, calculates a rotation angle of the first rotating body from the first angle detection signal and the second angle detection signal, and outputs a rotation torque signal generated based on the rotation torque and a rotation angle signal generated based on the rotation angle.

2. The rotation angle and torque detection device of claim 1,
wherein the first detecting body and the second detecting body mesh with each other by a first spur gear of the first detecting body and a second spur gear of the second detecting body, and a number of cogs of the first spur gear is different from a number of cogs of the second spur gear.

3. The rotation angle and torque detection device of claim 1,
wherein a first magnetic body and a second magnetic body are disposed so as to surround the first magnet.

4. The rotation angle and torque detection device of claim 1,
wherein a plurality of rectangular third magnetic bodies are arranged at a predetermined interval inside the second rotating body.

5. A rotation angle and torque detection device comprising:
a first rotating body;
a second rotating body that rotates together with the first rotating body;
a first magnet mounted on the first rotating body;
a first magnetism detecting element for detecting magnetism of the first magnet, and outputting it as a torque detection signal;
a first detecting body that rotates together with the first rotating body or the second rotating body;
a second magnet mounted on the first detecting body;
a second magnetism detecting element for detecting magnetism of the second magnet and outputting it as a first angle detection signal;
a second detecting body that rotates together with the first detecting body or the first rotating body;
a third magnet mounted on the second detecting body;
a third magnetism detecting element for detecting magnetism of the third magnet and outputting it as a second angle detection signal; and
a control circuit coupled to the first magnetism detecting element, the second magnetism detecting element, and the third magnetism detecting element;
wherein the second magnetism detecting element outputs the first angle detection signal to the control circuit and to outside of the rotation angle and torque detection device, and
the control circuit calculates rotation torque of the first rotating body from the torque detection signal, calculates a rotation angle of the first rotating body from the first angle detection signal and the second angle detection signal, and outputs a rotation torque signal generated based on the rotation torque and a rotation angle signal generated based on the rotation angle.

6. The rotation angle and torque detection device of claim 5, wherein the first detecting body and the second detecting body mesh with each other by a first spur gear of the first detecting body and a second spur gear of the second detecting body, and a number of cogs of the first spur gear is different from a number of cogs of the second spur gear.

7. The rotation angle and torque detection device of claim 5,
wherein a first magnetic body and a second magnetic body are disposed so as to surround the first magnet.

8. The rotation angle and torque detection device of claim 5,
wherein a plurality of rectangular third magnetic bodies are arranged at a predetermined interval inside the second rotating body.

9. A rotation angle and torque detection device comprising:
a first rotating body;
a second rotating body that rotates together with the first rotating body;
a first magnet mounted on the first rotating body;
a first magnetism detecting element for detecting magnetism of the first magnet, and outputting it as a torque detection signal;
a first detecting body that rotates together with the first rotating body or the second rotating body;
a second magnet mounted on the first detecting body;
a second magnetism detecting element for detecting magnetism of the second magnet and outputting it as a first angle detection signal;
a second detecting body that rotates together with the first detecting body or the first rotating body;
a third magnet mounted on the second detecting body;
a third magnetism detecting element for detecting magnetism of the third magnet and outputting it as a second angle detection signal; and
a control circuit coupled to the first magnetism detecting element, the second magnetism detecting element, and the third magnetism detecting element;
wherein the third magnetism detecting element outputs the second angle detection signal to the control circuit and to outside of the rotation angle and torque detection device, and,
the control circuit calculates rotation torque of the first rotating body from the torque detection signal, calculates a rotation angle of the first rotating body from the first angle detection signal and the second angle detection signal, and outputs a rotation torque signal generated based on the rotation torque and a rotation angle signal generated based on the rotation angle.

10. The rotation angle and torque detection device of claim 9,
wherein the first detecting body and the second detecting body mesh with each other by a first spur gear of the first detecting body and a second spur gear of the second detecting body, and a number of cogs of the first spur gear is different from a number of cogs of the second spur gear.

11. The rotation angle and torque detection device of claim 9,
wherein a first magnetic body and a second magnetic body are disposed so as to surround the first magnet.

12. The rotation angle and torque detection device of claim 9,
wherein a plurality of rectangular third magnetic bodies are arranged at a predetermined interval inside the second rotating body.
